(19) United States
(12) Patent Application Publication
(10) Pub. No.: US 2008/0271671 A1
(43) Pub. Date: Nov. 6, 2008

(54) Extrusion Nozzle for Extruding Hollow Profiles

(76) Inventor: Siegfried Topf, Traun (AT)

Correspondence Address: K.F. ROSS P.C., 5683 RIVERDALE AVENUE, SUITE 203 BOX 900, BRONX, NY, 10471-0900, US

(21) Appl. No.: 11/793,688

(22) PCT Filed: Dec. 23, 2005
(86) PCT No.: PCT/EP2005/057146

§ 371 Date: Jan. 4, 2008

(30) Foreign Application Priority Data
Dec. 23, 2004 (AT) A2160/2004

(51) Int. Cl. B05B 13/06

(52) U.S. Cl. 118/317

(57) ABSTRACT

The invention relates to an extrusion nozzle comprising at least one core (21-25). Said extrusion nozzle is also provided with a plurality of flow channels (11-19) for melt streams, said channels merging inside the extrusion nozzle to form the desired profiled element. The inventive extrusion nozzle consists of a plurality of plates (1-7). The flow channels (11-19) are separated from each other for all plates comprising at least one core (3-7), with the exception of the last plate (7), such that the at least one core (21-25) is connected to the remaining plate by the connecting elements (34-38) between the flow channels (11-20). When the flow channels (11-19) in the last plate (7) are continuously interconnected, the at least one core (21-25) of the last plate (7) is screwed onto the corresponding core or cores of the adjacent plate (6). When the flow channels (11-19) in the last plate (7) are interconnected only over part of the height thereof, the at least one core (21-25) of the last plate (7) is connected to the remaining plate (7) by means of the remaining connecting elements.

### TECHNICAL ENVIRONMENT

The present invention relates to an extrusion nozzle for extruding hollow profiles, in particular window profiles comprising one or a plurality of cores where a plurality of flow channels for melt streams merge to the desired profile inside the extrusion nozzle.

Extrusion is required in order to make the continuous production of profiles and semifinished products of plastic possible. The source materials, mostly thermoplastic polymers, are fed in the form of powders or granulates into an extruder, possibly along with additives such as dyes, fillers, reinforcement fibers, etc.

An extruder consists of a plurality of functional zones. The first functional zone is the solids-feed pay zone. Here, the plastic—present in the form of granulate, grit or powder—is pulled in and advanced. The advancement mechanism differs depending on the extruder concept. The other zones, for example, would be the heating-up zone in which the material is heated and precompressed, the compression zone, possibly a degasification zone, and the dosing zone, which is common for all concepts.

In the dosing zone the completely prepared polymer exits the extruder. When the cylinder is open, namely without the extrusion tool, the melt pressure at the end of the cylinder equals ambient pressure. When a tool is provided, a pressure maximum builds up that lies in the dosing zone or in the tool. During extrusion the resistance of the tool attached to the extruder must be overcome.

After the plastic passes through the tool that determines the geometry, its shape is determined with the aid of a calibration unit, typically consisting of a dry/wet unit, and temporarily set. Subsequently, cooling is continued by means of an attached vacuum in a spray or immersion bath up to far below the distortion temperature (for amorphous polymers) and/or the melt temperature (for partially crystalline polymers).

It is known (see for example DE 19707711) that extrusion tools are made of a plurality of stacked plates whose task it is to gradually reshape the circular solid profile of the strand of melt streaming out of the adapter, and, for example, to create a hollow profile. Technically this task can be solved by designing one or a plurality of the center plates as mandrel-holding plates with its point (toward the extruder) and mandrel (in the opposite direction). It is the task of the point and the mandrel to convert a solid strand into a hollow strand, in the simplest of cases, to form a tube. In the process the mandrel is connected with the outer part of the mandrel-holding plate via webs. Thus, the core is constituted by a single-piece mandrel.

The shaping plates consist for example of: a flange plate for mounting to the adapter; distribution plates that initiate the shaping; a plate with a distribution point; the mandrel-holding plate; an intermediate plate; one or a plurality of nozzle plates; and a mandrel attachment.

In the prior art a strand of melt issuing from an adapter is preshaped by the plate with spreader tip and the distribution plate or plates. Subsequently, the flow passage of the tip-holding plate and the mandrel-holding plate is traversed. The plastic is shaped so as to correspond to the product by the mandrel provided on the mandrel-holding plate that extends through to the end of the tool and the final nozzle plates surrounding the mandrel. In order to do this job technically the mandrel and its point must be connected by webs with the outer plate. To withstand the pressure of the melt that results from the tool resistance (flow resistance) and to ensure sufficient stability of the mandrel an appropriate number of support webs is required. As per design these support webs divide the strand of melt and are therefore made so as to promote flow. When the plastic merges again bonding occurs resulting in the possible formation of a flow line. The bonding also has the disadvantage that the seam reduces strength that can be revealed on the technical inspection of the profile.

The manufacture of such extrusion nozzles is very costly, mainly due to the mandrel-holding plate. This mandrel-holding plate including mandrel is manufactured from solid metal to achieve maximum strength which, on the one hand, means a great deal of material loss, and, on the other hand, is very labor-intensive: the reason is that a single workpiece must be used whose height is the same as the distance from the opening of the extrusion nozzle to the mandrel-holding plate, so that the mandrel reaches to the opening of the extrusion nozzle.

A device of the type mentioned at the beginning is known from DE 10126689. An extrusion nozzle is shown there that has four flow passages for melt streams. These four flow passages are fed by three extruders, i.e. one of the melt streams is divided. All the melt streams—regardless of how many parts are in the corresponding profile—are merged to a joint strand even within the extrusion tool and delivered to the calibration device as a single profile. However, no reference to the design of the extrusion nozzle can be found in this publication.

### DISCLOSURE OF THE INVENTION

### Technical Problem

It is the object of the present invention to create an extrusion nozzle of the type initially referred to that can be manufactured cost effectively, with the extruded profile still possessing high quality.

### Technical Solution

This object is attained according to the invention solved in that the extrusion nozzle is made up of a plurality of plates, the flow passages of all plates with core—with the exception of the last plate—being separated from one another, with the core and/or the cores being connected by the webs between the flow passages and the remaining plate.

Thus, according to the invention, the core is not realized by a one-piece mandrel, rather the corresponding core piece exists in each plate (except the last one) and is connected by the webs between the flow passages and the rest of the plate. As a result, all plates can be manufactured from suitably thin workpieces; a block—as with the familiar mandrel-holding plate—is not required. As a result manufacturing costs are relatively low.

This design provides for the division of the strand of melt in substrands. This way the extruder's influence can be better compensated for. The simple geometric shape and the separation of the substrands, uninterrupted by webs, gives a more stable flow. The individual flow passages can be optimized independent of one another.

A special advantage must also be seen in the fact that—even if one recognizes that the geometry of the flow passages is not optimal—there is no need to manufacture a new mandrel-holding plate including a mandrel from one new block. It is sufficient to make the appropriate plate again, since the core already exists inside this plate.

The flow passages of the last plate are no longer continuously separated from one another, since the subprofiles must be consolidated in the last plate.

Two embodiments are possible here:

If the flow passages in the last plate are continuously connected to one another, the core and/or the cores of the last plate can be screwed to the corresponding core and/or the corresponding cores of the adjacent plate. If the flow passages in the last plate are connected with one another only along a portion of their length, the webs between the flow passages extend over a portion of the height in the last plate, and the core and/or the cores of the last plate is and/or are connected through such webs with the remaining plate.

### BRIEF DESCRIPTION OF THE DRAWINGS

Based on the enclosed figures the invention is explained in greater detail.

FIG. 1 shows the first four plates of an extrusion nozzle according to the invention in exploded view;

FIG. 2 shows the remaining plates of the extrusion nozzle, again in exploded view;

FIG. 3 shows the extrusion nozzle assembled;

FIG. 4 shows the front plate of the extrusion nozzle, essentially from above;

FIG. 5 shows a detail of FIG. 4; and

FIG. 6 shows an alternative embodiment for the two last plates of the extrusion nozzle, again in exploded view. One fourth was cut away in all figures so that the flow passages can be seen in greater detail.

### BEST MODE OF USING THE INVENTION

Starting with a circular strand of melt in a flange plate 1 (FIG. 1), the melt strand is converted in a distribution plate 2 with a spreader tip 2′ to a circular profile. Here, the melt strand is reshaped to a profile larger than required by its shape. The thereby increased residence time of the extrudate results in a certain material relaxation, as is necessary for the desired higher output rate. Then, in additional plates 3 and 4 this circular profile is subdivided by segment-shaped flow passages 11-19. These segment-shaped flow passages 11-19 themselves form separate, independent flow passages, whose profiles and positions correspond to that of the eventually produced profile.

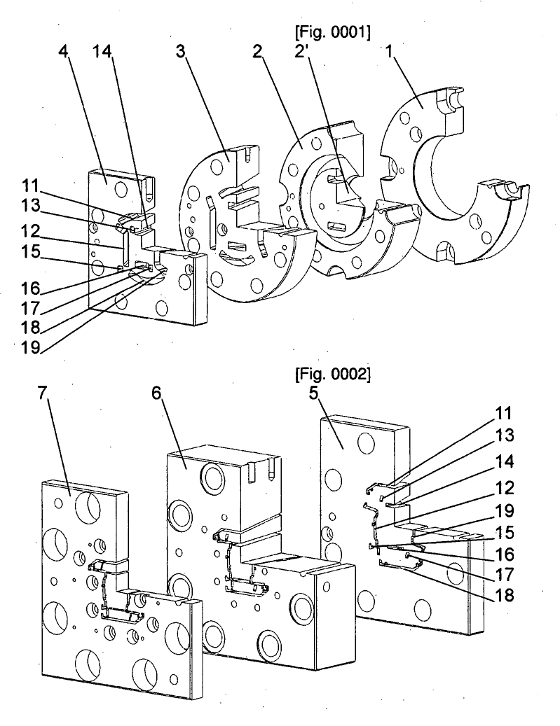

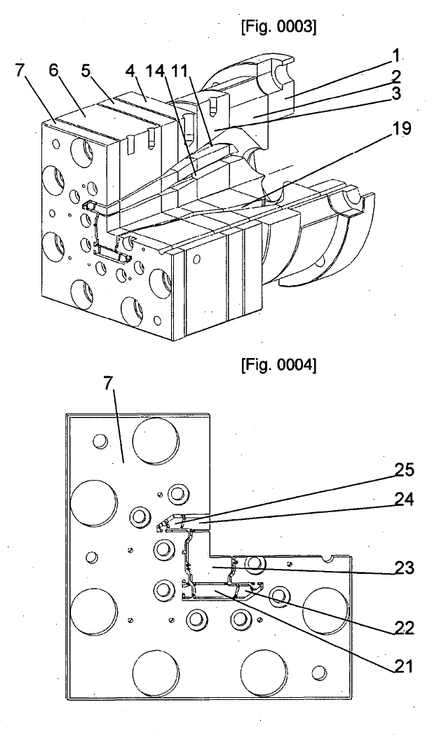

In the further plates 5, 6 and 7(FIG. 2) the segment-shaped flow passages 11-19 are gradually adapt to the subsequent profile shape with respect to their location and thickness. An essential part of the invention is that these segment-shaped flow passages 11-19 run separate from one another and that they are no longer interrupted by webs (see also FIG. 3).

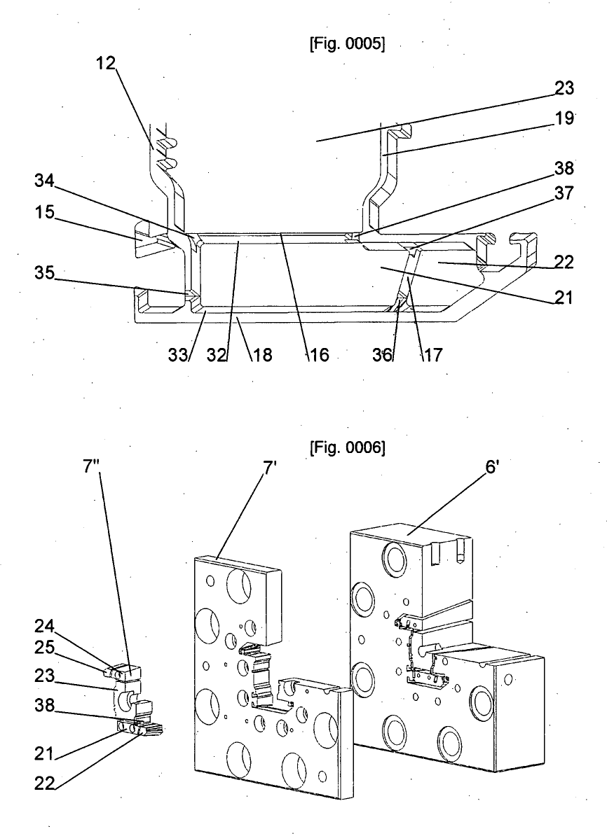

In an end plate 7 the partial segments are then merged. This plate 7 is illustrated in FIG. 4, and an enlarged profile can be seen in FIG. 5. Cores 21-25 can be clearly seen in FIG. 4, each of which is surrounded by flow passages. For example, core 21 is surrounded on all sides by flow passages 12, 16, 17, 18 and 19 (see FIG. 5).

In both figures, the plate 7 is essentially shown from above, the view is slightly from left and above. It must be noted that flow passages 12, 15, 16, 17, 18, 19 (see FIG. 5) do not run exactly parallel to one another. This way the upper side wall 32 as well as the lower side wall 33 of the core 21 can be seen.

This core 21 is connected via webs with the adjacent cores 22, 23 and/or with the remaining plate 7 (see FIG. 4): web 34 (see FIG. 5) bridges flow passages 12 and 16, web 35 bridges flow passages 12 and 18, web 36 bridges flow passages 17 and 18, web 37 bridges flow passages 17 and 19, and web 38 bridges flow passages 16 and 19.

Some of these webs, namely 34, 37 and 38, are flat on top, other bridges, namely 35 and 36, taper off to points. All the webs 34-37 have in common that they only extend over a portion of the thickness of the plate 7, i.e. they end below its end face. This way the melt streams in the individual flow passages can connect with one another downstream of the webs.

An alternative embodiment is illustrated in FIG. 6. Here, the individual cores 21-25 form a separate component 7″. The component 7″ is screwed to a plate 6′, and together with the remaining plate 7′ flow passages are formed extending through the entire height of plate 7′.

In this embodiment the individual cores 21-25 are connected via bridges (only bridge 38 can be seen in FIG. 6). Of course, it is also possible to screw each core 21-25 individually to the plate 6′ with the result that no more bridges exist at all in the last plate.

The design according to the invention manages without a mandrel-holding plate and mandrel. This way, the otherwise necessary mandrel-holding bridges with the above-mentioned disadvantages can be dispensed with. Additional advantages result from the simpler coordination of the flow front at the outlet.

One of the effects occurring during the extrusion of thermoplastic plastics, among other things, is an incompletely homogenous temperature distribution in the melt strand delivered to the tool. As a result of the irregular temperature distribution differences in viscosity occur that in turn cause melt flow disparities. This results in different exit speeds of the plastic across the profile and an increased coordination effort. With respect to the extrusion nozzle according to the invention this can be adjusted by selecting different profile widths for the individual flow passages, namely narrower profiles to compensate for viscosity that is too low, and wider profiles to compensate for viscosity that is too high.

According to this principle, it is also possible to create profiles with one or a plurality of coextruded layers and/or partial segments by feeding the individual flow passages with different extruders. It is also possible to create foamed profiles with this invention.

1. An extrusion nozzle for extruding hollow profiles, in particular window profiles, comprising one or a plurality of cores, where inside the extrusion nozzle a plurality of flow passages for melt streams merging to the desired profile inside the extrusion nozzle are provided wherein the extrusion nozzle is assembled from a plurality of plates, the flow passages of all plates with core, with the exception of the last plate, being separated from one another so that the core and/or the cores are connected by the webs between the flow passages and the rest of the respective plate.

2. The extrusion nozzle according to claim 1 wherein the flow passages in the last plate are continuously connected to one another and that the core and/or the cores of the last plate is screwed to the corresponding core and/or the corresponding cores of the adjacent plate.

3. The extrusion nozzle according to claim 1 wherein the flow passages in the last plate are connected with one another only through a portion of their length so that the webs between the flow passages extend over a portion of the length in the last plate and connect the core and/or the cores of the last plate with the remaining plate.
